(19) United States
(12) Patent Application Publication
(10) Pub. No.: US 2007/0053146 A1
(43) Pub. Date: Mar. 8, 2007

(54) Packing assembly for display module

(76) Inventors: Hyun-Ye Lee, Suwon-si (KR); In-Soo Cho, Suwon-si (KR); Tae-Sin Hwang, Suwon-si (KR); Hyuk Kim, Suwon-si (KR); Dong-Hyok Shin, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/515,086

(22) Filed: Sep. 1, 2006

(30) Foreign Application Priority Data
Sep. 2, 2005 (KR) 10-2005-0081753

(51) Int. Cl. G06F 1/16

(52) U.S. Cl. 361/681

(57) ABSTRACT

A packing assembly for display modules is disclosed. In one embodiment, the packing assembly includes a plurality of packing modules stacked on one another and configured to receive a plurality of display modules, each packing module comprising a seating unit where the display module is seated and a first rim unit that surrounds at least a portion of each of the display modules and a plurality of protection members covering the circuit unit to prevent the panel from being damaged by a collision between a circuit unit of a display module and a panel of another display module. According to one embodiment, transportation costs are reduced by loading and transporting more display modules in a given packing assembly.

### CROSS-REFERENCE TO RELATED PATENT APPLICATION

This application claims the benefit of Korean Patent Application No. 10-2005-0081753, filed on Sep. 2, 2005, in the Korean Intellectual Property Office, the disclosure of which is incorporated herein in its entirety by reference. This application also relates to U.S. patent application (Attorney Docket Number: SDIYPL.113AUS) entitled “PACKING MODULE AND PACKING ASSEMBLY COMPRISING THE SAME,” concurrently filed as this application, which is incorporated by reference.

### BACKGROUND OF THE INVENTION

1. Field of the Invention

The present invention relates to a packing assembly for a display module.

2. Description of the Related Technology

Recently, display devices that use a liquid crystal display panel or a plasma display panel have received attention due to their excellent characteristics, such as high image quality, super slim shape, light weight, and a wide viewing angle with a large screen size.

Hereinafter, a display module denotes a combination of a display panel, a chassis base that supports the display panel, and driving units, or a final product in which a case is added to the combination of the display panel, the chassis base, and the driving units. The display module further denotes a combination of only the circuit units and the chassis base without including the display panel.

FIG. 1 is a schematic perspective view of a conventional packing assembly for the transportation of plasma display modules.

Referring to FIG. 1, a plurality of plasma display modules 10 are transported in a box shaped container 90 in a upright position. However, when the plasma display modules 10 are vertically positioned, the weight of the plasma display modules 10 is concentrated along sides of the plasma display modules 10. Therefore, the plasma display modules 10 can be easily damaged by vibrations or external impact and can be bent due to self-weight. To solve this problem, an additional buffer material is disposed in the container 90. However, since the buffer material occupies an internal space of the container 90, the number of plasma display modules 10 that can be loaded in the container 90 is reduced. Accordingly, the cost of the buffer material and the reduced number of the plasma display modules 10 in each container 90 increase the transportation cost of the plasma display modules 10.

### SUMMARY OF CERTAIN INVENTIVE ASPECTS

One aspect of the present invention provides a display module packing assembly that reduces transportation costs by increasing a loading rate of the plasma display modules for transporting a plurality of plasma display modules. Another aspect of the present invention also provides a display module packing assembly that can safely transport plasma display modules without damaging them.

Another aspect of the present invention provides a packing assembly comprising: a plurality of display modules, each comprising a panel, a chassis disposed on a rear of the panel to support the panel, and a circuit unit mounted on the chassis, a plurality of packing modules in which the display modules are stacked one another, each packing module comprising a seating unit where the display module is seated and a first rim unit that surrounds at least a portion of each of the display modules and a plurality of protection members each covering the circuit unit of each display module to prevent the panel from being damaged by a collision between a circuit unit of a display module and a panel of another display module.

Each of the display modules may comprise a plurality of circuit units and the protection member may cover the highest circuit unit from the chassis among the circuit units.

Each of the display modules may comprise a plurality of circuit units and the protection member may cover the nearest circuit unit from a central portion of the chassis among the circuit units.

In one embodiment, the protection member is formed of expanded polypropylene (EPP), expanded polyethylene (EPE), or expanded polyurethane (EPU).

Another aspect of the invention provides a packing assembly for display modules, comprising: a plurality of stacked packing modules configured to receive a plurality of display modules, wherein each packing module comprises a seating unit configured to receive a respective display module, wherein the seating unit includes a protrusion extending toward an adjacent display module, and wherein the protrusion contacts at least a portion of the adjacent display module so as to minimize movement of the adjacent display module.

Still another aspect of the invention provides a method of using a packing assembly for display modules, comprising: i) providing a plurality of stacked packing modules, each packing module comprising a seating unit where a respective display module is seated and a rim unit that surrounds at least a portion of each of the display modules, ii) placing a plurality of display modules in a respective seating unit and iii) covering a circuit unit of each display module.

### BRIEF DESCRIPTION OF THE DRAWINGS

Embodiments of the present invention will be described with reference to the attached drawings.

FIG. 1 is a schematic perspective view of a conventional packing assembly for the transportation of plasma display modules.

FIG. 2 is a cross-sectional view of a packing assembly according to an embodiment of the present invention.

FIG. 3 is a perspective view of one of a plurality of plasma display modules depicted in FIG. 2 according to an embodiment of the present invention.

FIG. 4 is a perspective view of a packing module depicted in FIG. 2 according to an embodiment of the present invention;

FIG. 5 is a cross-sectional view taken along a line V-V of FIG. 4 according to an embodiment of the present invention.

FIG. 6 is a perspective view of a stacked structure of a plurality of the packing modules of FIG. 4 according to an embodiment of the present invention.

FIG. 7 is an enlarged perspective view of a connection member depicted in FIG. 6 according to an embodiment of the present invention.

FIG. 8 is a cross-sectional view of a first modified version of a protection member depicted in FIG. 2 according to an embodiment of the present invention.

FIG. 9 is a cross-sectional view of a second modified version of the protection member depicted in FIG. 2 according to another embodiment of the present invention.

FIG. 10 is a cross-sectional view of a third modified version of the protection member depicted in FIG. 2 according to another embodiment of the present invention.

### DETAILED DESCRIPTION OF THE INVENTION

Hereinafter, embodiments of the present invention will be described in detail with reference to the attached drawings. Like reference numerals refer to like elements throughout the drawings.

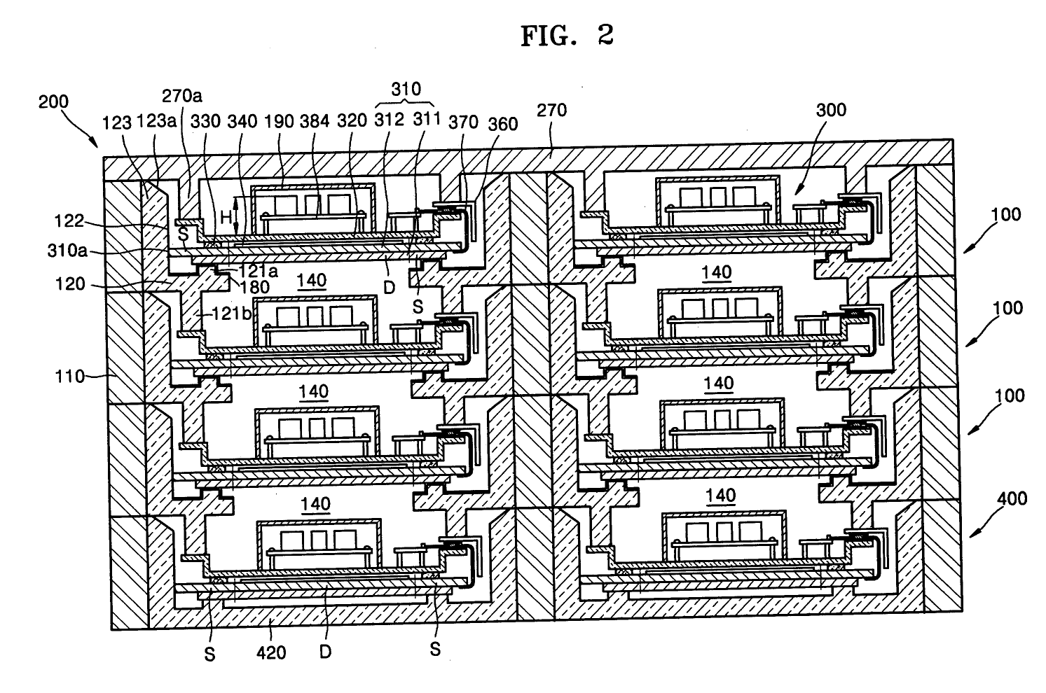

FIG. 2 is a cross-sectional view of a packing assembly 200 according to an embodiment of the present invention.

In one embodiment, as shown in FIG. 2, the packing assembly 200 includes a plurality of display modules 300, a plurality of packing modules 100 and 400, a cover 270, and a plurality of protection members 190. In another embodiment, the packing assembly 200 may exclude the plurality of display modules 300.

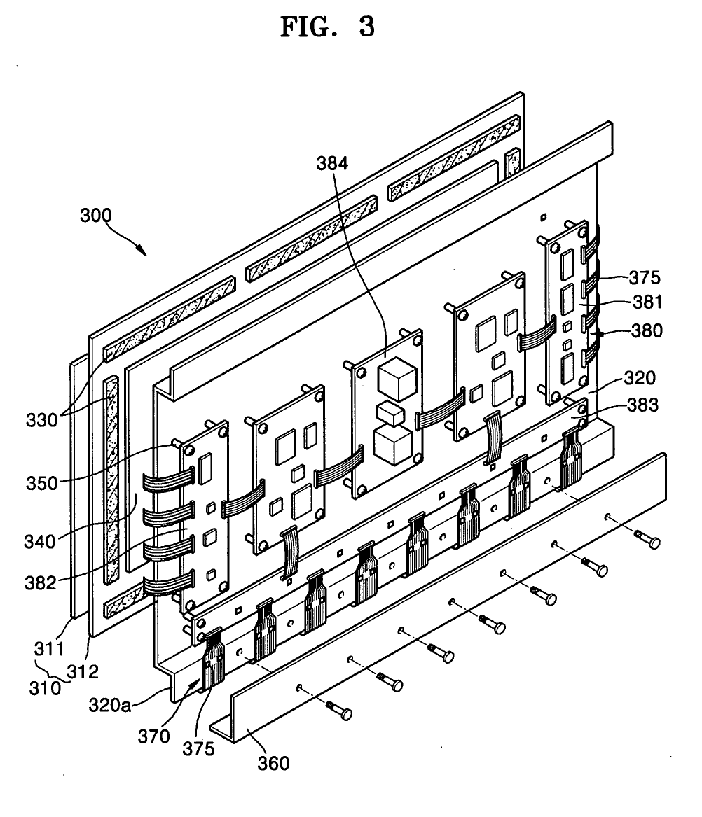

The display modules 300 can be various display modules such as plasma display modules, liquid crystal modules, etc. A plasma display module is illustrated in FIG. 2 as an example of the display module 300. For convenience of understanding, a perspective view of the display module of FIG. 2 is illustrated in FIG. 3.

Referring to FIGS. 2 and 3, each plasma display module 300 includes a plasma display panel 310, a chassis 320, and a plurality of circuit units 380.

The plasma display panel 310 displays an image using a gas discharge, and includes a front panel 311 and a rear panel 312. The chassis 320 is disposed on a rear of the plasma display panel 310 to support the plasma display panel 310.

In one embodiment, a thermal conductive sheet 340 is interposed between the plasma display panel 310 and the chassis 320 to mainly dissipate heat generated from the plasma display panel 310. In one embodiment, the plasma display panel 310 and the chassis 320 are coupled to each other using a double-sided tape 330.

The circuit units 380 are disposed on a rear of the chassis 320, and the circuit units 380 include circuits for driving the plasma display panel 310. The circuit units 380 are separated by a predetermined distance from the rear surface of the chassis 320, and are coupled to the chassis 320 using, a coupling member, for example, a screw (not shown) and bosses 350 inserted into the chassis 320. In one embodiment, the circuit units 380 include an X driving unit 381 and a Y driving unit 382 for driving sustain electrodes of the plasma display panel 310, an address driving unit 383 for driving address electrodes, and a switching mode power supply (SMPS) 384 as a power supply device for driving three driving units 381-383. In one embodiment, the SMPS 384 is located adjacent to a central portion of the chassis 320 and has a height H relatively higher than the other circuit units 380.

The circuit units 380 transmit electrical signals to the plasma display panel 310 through signal transmitting elements, such as a flexible printed cable (FPC), a tape carrier package (TCP), a chip-on-film (COF), etc. In one embodiment, the signal transmitting elements disposed on a rear lower portion of the chassis 320 are TCPs 370, and the signal transmitting elements disposed on left and right sides of the chassis 320 are FPCs 375. The TCPs 370 can be replaced by COFs.

Upper and lower edge portions of the chassis 320 are bent, and a lower bent edge portion 320a supports the TCPs 370. An end of each of the TCPs 370 is connected to the address driving unit 383. The TCPs 370 are extended to surround the lower edge portion of the chassis 320 and are connected to address electrodes of the plasma display panel 310.

Also, the plasma display modules 300 may further include a heat dissipation member 360 covering the TCPs 370. In one embodiment, the heat dissipation member 360 dissipates heat generated from electronic devices 375 in the TCPs 370 and protects the TCPs 370 from being damaged.

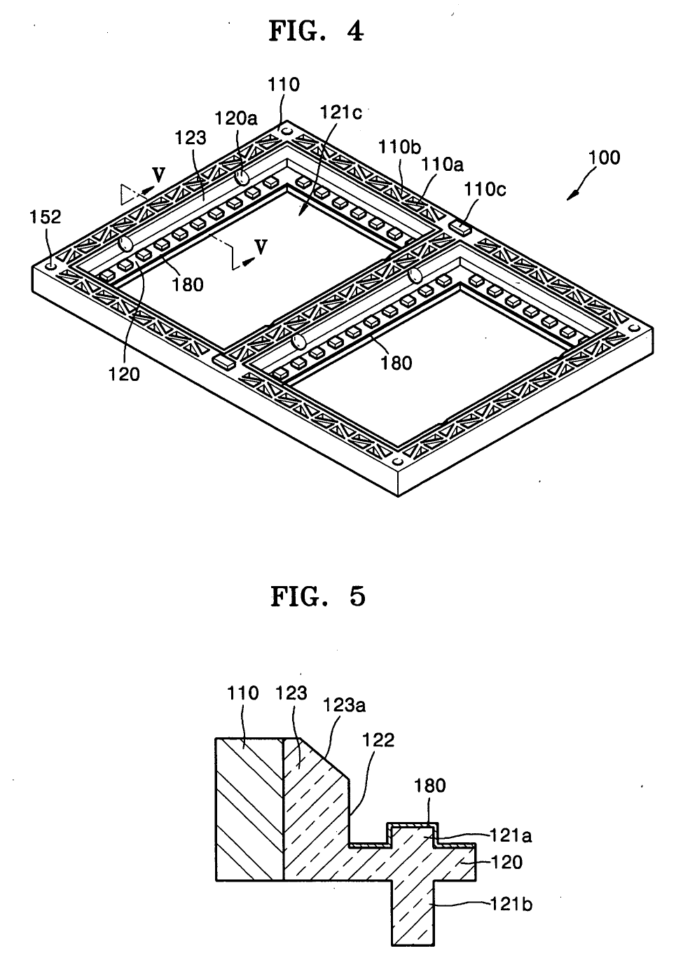

In one embodiment, as depicted in FIG. 2, each plasma display module 300 is horizontally seated in each of the packing modules 100 with respect to the packing module 100. FIG. 4 is a perspective view of one of the packing modules 100 depicted in FIG. 2 according to an embodiment of the present invention, and FIG. 5 is a cross-sectional view taken along a line V-V of FIG. 4 according to an embodiment of the present invention. Referring to FIGS. 4 and 5, each packing module 100 includes a seating unit 120, a first rim unit 123, and a second rim unit 110. The seating unit 120 is for seating the plasma display module 300. In one embodiment, the first rim unit 123 is connected to a side of the seating unit 120, and is disposed to surround the plasma display module 300. The seating unit 120 and the first rim unit 123 may be one body for ease of manufacturing purposes.

In one embodiment, the second rim unit 110 surrounds the first rim unit 123. The packing module 100 includes two horizontally disposed seating units 120 having the same structure, and can accommodate two plasma display modules 300. The seating unit 120 is not limited thereto, that is, each packing module 100 can include one seating unit 120 or more than three horizontally disposed seating units 120.

In one embodiment, the second rim unit 110 includes a plurality of ribs 110a. The ribs 110a reinforce the strength of the second rim unit 110. Grooves 110b formed between the ribs 110a reduce the weight of the second rim unit 110.

In one embodiment, an opening 121c is formed in a central portion of the seating unit 120. The opening 121c reduces the weight of the seating unit 120 and increases seating space 140, thereby improving workability.

In one embodiment, seating grooves 120a for ease of seating of the plasma display module 300 are formed in the seating unit 120. Accordingly, the plasma display module 300 can be easily lifted or seated by hand in the seating grooves 120a.

In one embodiment, the seating unit 120 includes a plurality of non-continuous protrusions 121a. In one embodiment, the protrusions 121a function as a buffer for preventing the plasma display module 300 from being damaged due to vibrations or impacts caused during seating the plasma display module 300 in the seating unit 120 or during transportation after the plasma display module 300 is seated in the seating unit 120. The protrusions 121a can be formed in one body with the seating unit 120.

Also, an anti-sliding layer 180 having a predetermined thickness can be formed on the seating unit 120. The anti-sliding layer 180 prevents sliding of the plasma display module 300, and can be formed by coating silicon or a resin of a rubber group on the seating unit 120 and the protrusions 121a. The anti-sliding layer 180 can also be formed on the plasma display module 300 where the plasma display module 300 directly contacts the packing modules 100 and 400.

As described above, the plasma display module 300 is horizontally seated in a seating space 140 defined by the seating unit 120 of each of the packing modules 100 and 400. More specifically, a front face of the plasma display panel 310 is seated on the protrusions 121a, to be more precise, on the anti-sliding layer 180. At this time, portions of non-display regions S of the plasma display panel 310 may be seated on the anti-sliding layer 180 to avoid damage to an internal structure or a scratch of the plasma display panel 310, which can be caused when the packing modules 100 and 400 and a display region D of the plasma display panel 310 directly contact each other. In particular, when a film filter is attached on the front face of the plasma display panel 310, portions of the film filter corresponding to the non-display region S of the plasma display panel 310 may be seated on the anti-sliding layer 180. When the film filter is attached mainly on the display region D of the plasma display panel 310, the non-display region S of the plasma display panel 310 may be directly seated on the anti-sliding layer 180.

The first rim unit 123 may have a height that can accommodate the plasma display module 300 and can prevent the plasma display module 300 moving in the seating unit 120 when the packing assembly 200 is transported. In one embodiment, side surfaces 310a of the plasma display panel 310 directly contact side surfaces 122 of the first rim unit 123 to absorb impact caused during transportation and to prevent the plasma display module 300 moving in the seating unit 120. In one embodiment, a plurality of non-continuous protrusions 121b are formed on a lower surface of the seating unit 120. In one embodiment, the protrusions 121b are stacked pressing the bending unit 320a of the chassis 320. Accordingly, the plasma display modules 300 are further safely fixed in the packing assembly 200 without an additional buffer material, thereby increasing the number of plasma display modules 300 that can be loaded in the packing assembly 200. This results in the reduction of packing and transportation costs of the packing assembly 200.

An upper surface of the first rim unit 123 is substantially the same level as the upper surface of the second rim unit 110. In one embodiment, a taper portion 123a is formed on an upper portion of the first rim unit 123. In one embodiment, a slope is formed downwards from the taper portion 123a to guide the plasma display module 300 to be safely seated on the seating unit 120 along the taper portion 123a when the plasma display module 300 is seated on the seating unit 120, thereby improving work efficiency.

The seating unit 120, the first rim unit 123, and the second rim unit 110 can be formed of various materials, for example, wood board, plastic material, metals. etc.

The seating unit 120 and the first rim unit 123 may be formed of the same material, and the second rim unit 110 may be formed of a different material from the seating unit 120 and the first rim unit 123. At this time, the material for forming the second rim unit 110 may have a higher strength than the material for forming the seating unit 120 and the first rim unit 123. This is because the second rim unit 110 maintains an overall skeleton of the packing module 100 and prevents damage of the plasma display panel 310 from external impact. Also, since the seating unit 120 and the first rim unit 123 directly contact or can contact the plasma display module 300, the seating unit 120 and the first rim unit 123 may be formed of a relatively soft material.

To make the second rim unit 110 having a different strength from the seating unit 120 and the first rim unit 123, the second rim unit 110 may be formed to have a different density from the seating unit 120 and the first rim unit 123. For example, the second rim unit 110 and the seating unit 120 can be formed of expanded polypropylene (EPP), expanded polyethylene (EPE), expanded polyurethane (EPI) etc. At this time, the second rim unit 110 may have a density of about 60 to about 70 kg/m³, and the seating unit 120 and the first rim unit 123 may have a density of about 25 to about 35 kg/m³.

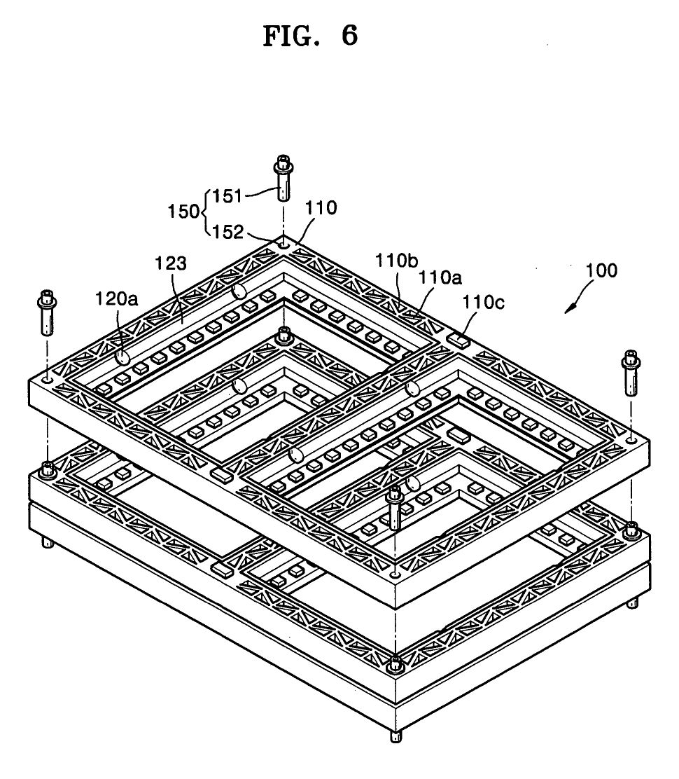

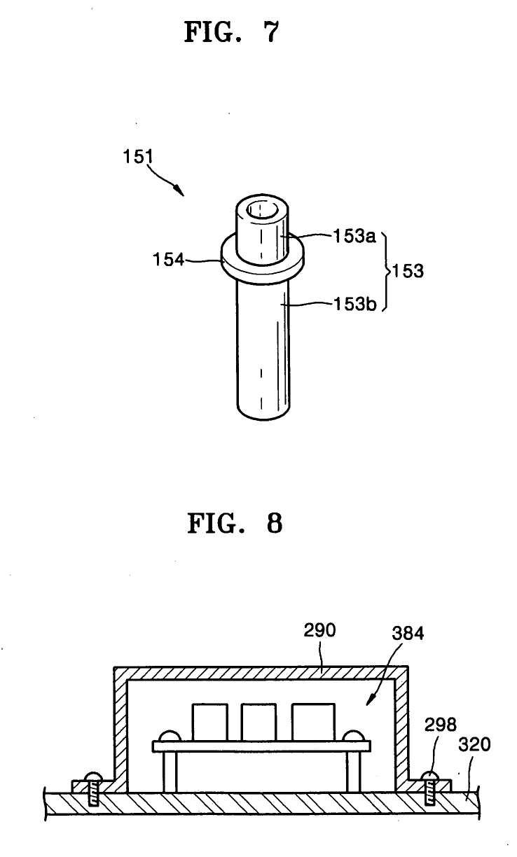

FIG. 6 is a perspective view of a stacked structure of the packing modules 100 of FIG. 4. In one embodiment, as illustrated in FIG. 6, the packing modules 100 are stacked on top of one another, and are fixed together by fixing elements 150. In this embodiment, connection holes 152 are formed on each corner portion of the second rim unit 110 through the second rim unit 110. In one embodiment, a connection member 151 is inserted in each connection hole 152. FIG. 7 is an enlarged perspective view of the connection member 151 depicted in FIG. 6 according to an embodiment of the present invention. Referring to FIG. 7, the connection member 151 includes a hollow-cylinder shaped main body portion 153 and a wing portion 154 formed around a circumference of the main body portion 153. In one embodiment, the main body portion 153 is inserted into the connection hole 152 in a fitting state. In one embodiment, an upper main body portion 153a defined by the wing unit portion 154 is inserted into the connection hole 152 of the upper packing module, and a lower main body portion 153b is inserted into the connection hole 152 of the lower packing module. Therefore, the upper packing module and the lower packing module can be fixed to each other.

In one embodiment, protrusions 110c are formed on an upper surface of the second rim unit 110, and concave units (not shown) are formed on a lower surface of the second rim unit 110. In one embodiment, when the packing modules 100 are stacked, the protrusions 110c of the upper surface of the second rim unit 110 of a lower packing module 100 are inserted into the concave units of the lower surface of the second rim unit 110 of an upper packing module 100. In this embodiment, the connection between the upper and lower packing modules 100 are fixed.

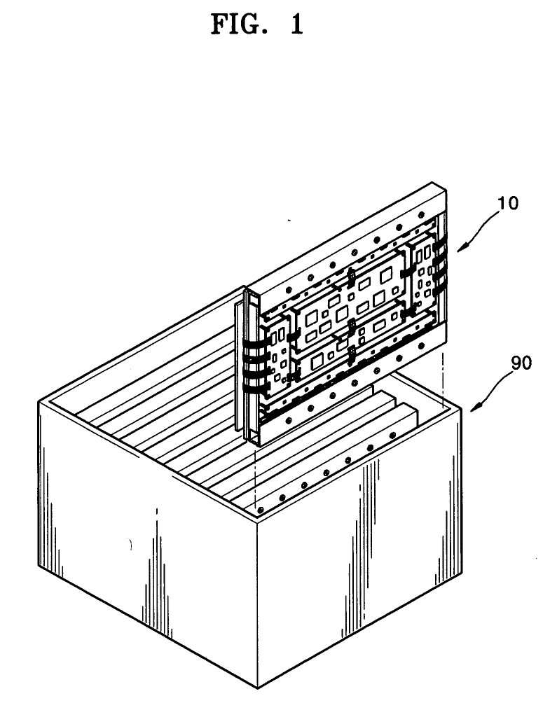

Referring to FIG. 1 again, the cover 270 is coupled to an uppermost portion of the packing module 100. The cover 270 prevents the plasma display module 300 being damaged by moisture or dust infiltrated into the seating space 140, thereby improving air-tightness of the seating space 140. The cover 270 may be formed of substantially the same material as the second rim unit 110 of the packing module 100.

In one embodiment, the lowermost seating unit 420 of the packing module 400 does not have an opening 121c to avoid entering moisture or dust into the seating space 140 since the moisture or dust can damage the plasma display module 300. However, other portions of the packing module 400 have the same structure as the packing module 100 depicted in FIG. 4, and thus, detailed descriptions thereof are omitted.

Referring to FIG. 2, the protection members 190 covering each of the SMPSs 384 are depicted. The protection members 190 are disposed to protect the plasma display panel 310. More specifically, when the plasma display modules 300 are transported while stacked in the packing module 100, the plasma display modules 300 move up and down in the packing module 100. Due to the movement of the plasma display modules 300, a plasma display module 300 stacked can collide with a plasma display module 300 stacked above through the opening 121c. The movement of the plasma display module 300 is larger at the central portion of the plasma display module 300. In particular, even though the circuit unit 380 is not disposed on the central portion of the plasma display module 300, the circuit unit 380, which is the highest (H) from the chassis 320, has a high possibility of colliding with the plasma display module 300 located above when the circuit unit 380 is moved even slightly. When the plasma display module 300 and the circuit unit 380 collide with each other, the plasma display panel 310 can be seriously damaged. If the plasma display panel 310 has a film filter on the front face thereof, the film filter can be torn. However, the protection member 190 covering the SPMS 384 can prevent a direct collision between the plasma display panel 310 and the SMPS 384, thereby preventing damage of the plasma display panel 310. However, according to the above embodiment, the protection member 190 covers the SMPSs 384, but the present invention is not limited thereto. That is, the protection member 190 can cover other circuit units 380 that can damage the plasma display module 300.

The protection member 190 may be formed of various materials, such as expanded polypropylene (EPP), expanded polyethylene (EPE), expanded polyurethane (EPU), etc. However, the present invention is not limited thereto.

Also, in the current embodiment, the protection member 190 is not fixed on the chassis 320 or the packing module 100. Therefore, the packing procedure is that a plasma display module 300 is seated on a packing module 100, and afterward, the SMPS 384 is covered by the protection member 190, and another plasma display module 300 is stacked on another packing module 100.

However, as depicted in FIG. 8, a protection member 290 can be fixed on the chassis 320. FIG. 8 is a cross-sectional view of a first modified version of the protection member 190 depicted in FIG. 2 according to an embodiment of the present invention. In this case, a process for disposing the protection member 290 is unnecessary, thereby increasing work efficiency. The protection member 290 is fixed to the chassis 320 using screws 298. Also, after a boss (not shown) is inserted in the chassis 320, the protection member 290 can be fixed by coupling the boss and the screw 298. In particular, when the protection member 290 is formed of a conductive material, the protection member 290 shields electromagnetic waves generated from the SMPS 384.

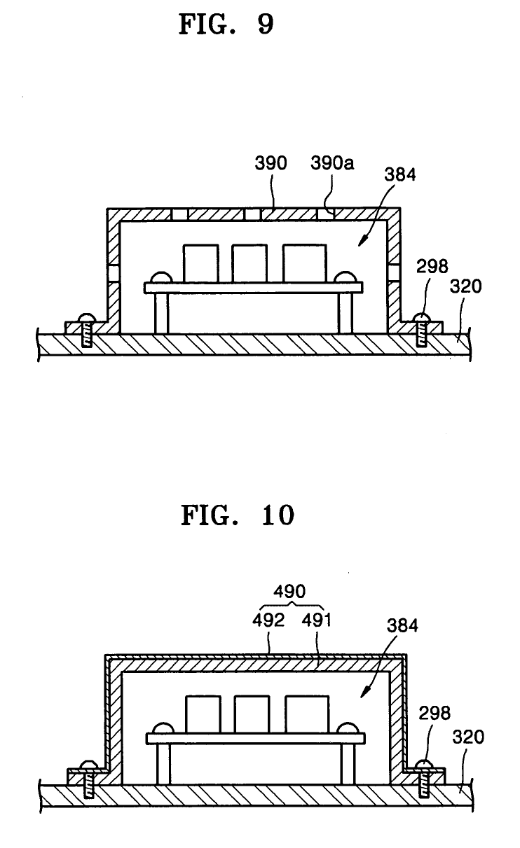

FIG. 9 is a cross-sectional view of a second modified version of the protection member 190 depicted in FIG. 2 according to another embodiment of the present invention. In one embodiment, as shown in FIG. 9, a protection member 390 includes holes 390a for dissipating heat. When a circuit unit such as the SMPS 384 is driven, a large amount of heat is generated. The holes 390a allow external air to flow smoothly, thereby promoting heat dissipation. The protection member 390 is fixed to the chassis 320 using, for example, screws 298.

FIG. 10 is a cross-sectional view of a third modified version of the protection member 190 depicted in FIG. 2. In one embodiment, as illustrated in FIG. 10, a protection member 490 includes a non-conductive main body 491 and a conductive layer 492 formed on the non-conductive main body 491. In one embodiment, the non-conductive main body 491 is formed of a bumper material to reduce damage by an impact. The conductive layer 492 shields electromagnetic waves generated from the SMPS 384. In one embodiment, the protection member 490 is fixed to the chassis 320 using, for example, screws 298.

The packing assembly for display modules according to embodiments of the present invention has the following advantages.

First, the packing assembly has a large seating space since the display modules are loaded without buffer materials. Therefore, a larger number of display modules can be loaded than a conventional packing assembly in a similar-sized packing assembly, thereby reducing packing costs and transportation costs.

Second, since the display modules are safely seated in a packing module, damage of the display modules can be prevented when the packing assembly is packed or transported. In particular, collisions between display modules stacked on one another can be prevented by protection members, thereby allowing safe transportation of the display modules.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A packing assembly, comprising:
a plurality of display modules, each comprising a panel, a chassis disposed on a rear of the panel to support the panel, and a circuit unit mounted on the chassis;
a plurality of packing modules in which the display modules are stacked one another, each packing module comprising a seating unit where the display module is seated and a first rim unit that surrounds at least a portion of each of the display modules; and
a plurality of protection members, each covering the circuit unit of each display module, configured to protect the circuit unit of a display module.

2. The packing assembly of claim 1, wherein the circuit unit is a power supply device configured to supply power to the panel.

3. The packing assembly of claim 1, wherein each of the display modules comprises a plurality of circuit units having different heights, and wherein the protection member is configured to cover the highest circuit unit from the chassis among the circuit units.

4. The packing assembly of claim 1, wherein each of the display modules comprises a plurality of circuit units having different distances from a central portion of the chassis, and wherein the protection member is configured to cover the nearest circuit unit from the central portion among the circuit units.

5. The packing assembly of claim 1, wherein the protection member is formed of one of expanded polypropylene (EPP), expanded polyethylene (EPE), and expanded polyurethane (EPU).

6. The packing assembly of claim 1, wherein the protection member comprises a conductive material.

7. The packing assembly of claim 6, wherein the protection member comprises a non-conductive main body and a conductive layer formed on the non-conductive main body.

8. The packing assembly of claim 1, wherein the protection member comprises holes configured to dissipate heat.

9. The packing assembly of claim 1, wherein the protection member is fixed to the chassis.

10. The packing assembly of claim 1, wherein each of the packing modules comprises a plurality of horizontally disposed seating units.

11. The packing assembly of claim 1, further comprising a fixing element configured to fix the packing modules stacked on one another.

12. The packing assembly of claim 1, further comprising a cover coupled to an uppermost packing module.

13. The packing assembly of claim 1, wherein portions of the panel corresponding to a non-display region contact the seating unit.

14. The packing assembly of claim 1, wherein the seating unit comprises a plurality of protrusions.

15. The packing assembly of claim 1, wherein each of the packing modules further comprises a second rim unit that surrounds at least a portion of the first rim unit.

16. The packing assembly of claim 15, wherein the first rim unit and the second rim unit of the packing module are integrally formed.

17. The packing assembly of claim 15, wherein the first rim unit, the second rim unit, and the seating unit of the packing module are integrally formed.

18. The packing assembly of claim 15, wherein the second rim unit has a higher strength than the first rim unit.

19. The packing assembly of claim 1, wherein the seating unit and the first rim unit of the packing module are integrally formed.

20. The packing assembly of claim 1, wherein the first rim unit comprises a taper portion configured to guide each display module on an inner surface.

21. The packing assembly of claim 1, wherein the seating unit comprises at least one opening.

22. The packing assembly of claim 1, further comprising an anti-sliding layer on portions of the seating unit contacting each display module.

23. The packing assembly of claim 1, wherein the seating unit comprises seating grooves configured to seat each display module.

24. The packing assembly of claim 1, wherein the display modules are horizontally seated in the seating unit.

25. A packing assembly for display modules, comprising:
a plurality of stacked packing modules configured to receive a plurality of display modules, wherein each packing module comprises a seating unit configured to receive a respective display module, wherein the seating unit includes a protrusion extending toward an adjacent display module, and wherein the protrusion contacts at least a portion of the adjacent display module so as to minimize movement of the adjacent display module.
